(19) United States
(12) Patent Application Publication
(10) Pub. No.: US 2011/0303046 A1
(43) Pub. Date: Dec. 15, 2011

(54) Damper Element for Springs and Vehicle Pedal Assembly Incorporating the Same

(76) Inventor: Nicholas K. Gentry, Columbus, IN (US)

(21) Appl. No.: 13/154,979

(22) Filed: Jun. 7, 2011

Related U.S. Application Data
(60) Provisional application No. 61/355,067, filed on Jun. 15, 2010.

(51) Int. Cl. F16F 3/00; G05G 1/44

(52) U.S. Cl. 74/560; 267/136

(57) ABSTRACT

A spring damper element in the form of a cap made of an elastomeric material and adapted to be mounted over the end of a coil spring. In one embodiment, the cap includes a top circumferential wall defining a central opening and a circumferential side wall depending outwardly from a peripheral circumferential edge of the top wall. In one embodiment, the cap is used in a vehicle pedal assembly to eliminate contact and noise between the inner and outer coil springs of a double coil spring assembly extending between the base and the pedal arm. In this embodiment, the top wall of the cap is seated against the top of the end of the inner coil spring and the side wall extends and is wedged between the inner and outer coil springs.

### CROSS-REFERENCE TO RELATED APPLICATIONS

This application claims the benefit of the filing date and disclosure of U.S. Provisional Patent Application Ser. No. 61/355,067 filed on Jun. 15, 2010, the entire disclosure of which is explicitly incorporated herein by reference as are all references cited therein.

### FIELD OF THE INVENTION

The present invention relates generally to springs and, more specifically, to an element adapted to dampen the vibration noise created by springs mounted in various types of assemblies including, for example, vehicle pedal assemblies.

### BACKGROUND OF THE INVENTION

Springs are common mechanical elements used in a variety of mechanisms and assemblies for the purpose of storing/releasing energy and/or maintaining forces between surfaces. U.S. Pat. No. 7,404,342 discloses the use of a spring in a vehicle pedal assembly for the purpose of applying a force to a vehicle pedal friction mechanism.

Because some springs are located in the cavities and housings of assemblies such as vehicle pedal assemblies which may be subject to vibration, there is a tendency for springs to contact or rub against the surface of the assembly housing, or for adjacent coils of a spring to contact and rub against each other, or for multiple springs in the assembly to contact and rub against each other, all causing and creating undesirable spring noise.

In the past, wedges made of foam or the like dampening material have been used to dampen spring noise. A disadvantage associated with the use of foam wedges, however, has been the risk of dislodgment and travel of the foam wedges to other areas of the vehicle pedal assembly.

The present invention is directed to an improved spring damper element which not only eliminates undesirable spring noise but also simplifies and assists in the spring assembly and seating process.

### SUMMARY OF THE INVENTION

The present invention relates generally to a spring damper element adapted for use in a double coil spring assembly including an inner and outer coil spring, the spring damper element comprising a top wall and a side wall depending from the side wall and defining an interior shoulder which is adapted to be seated against the end of the inner coil spring, the side wall being adapted to extend between the inner and outer coil springs of the double coil spring assembly.

In one embodiment, the spring damper element is in the form of a cap which includes a roof defined by the top wall and adapted to abut against a top surface of the end of the inner coil spring and a generally cylindrically-shaped side wall which depends from an edge of the roof and is adapted to surround the end of the inner coil spring.

In one embodiment, the top wall of the spring damper element or cap includes an interior edge defining a central opening in the top wall.

In one particular embodiment, the present invention is directed to a cap made from elastomeric material and adapted to be seated over the end of the inner coil spring of a double coil spring assembly which includes the inner coil spring and an outer coil spring. In this embodiment, the cap comprises a top wall which includes an outer circumferential edge and an inner circumferential edge defining a central opening in the top wall, the top wall being adapted to be seated against a top surface of the inner coil spring, and a circumferentially extending side wall projects outwardly from the outer circumferential edge of the top wall, the side wall being adapted to extend in a space defined between the inner and the outer coil springs of the double coil spring assembly.

In one embodiment, the top wall and the side wall of the spring damper element or cap define an interior shoulder adapted to be seated against the end of the inner coil spring.

In another particular embodiment, the present invention is directed to a vehicle pedal assembly comprising at least a base, a pedal arm, a first spring located between the base and the pedal arm and adapted to bias the pedal arm away from the base, and a spring damper cap which is seated over one of the ends of the coil spring and abuts against the pedal arm or the base.

In one embodiment, the pedal arm of the vehicle pedal assembly includes an interior surface defining a recess, the spring damper cap being received in the recess in the pedal arm.

In one embodiment, the vehicle pedal assembly further comprises a double coil spring assembly which extends between the base and the pedal arm and includes inner and outer coil springs. The first spring defines the inner coil spring and is located inside the outer spring, and the spring damper cap includes a side wall extending between the inner and outer coil springs.

In one embodiment, the spring damper cap includes a top wall with a beveled surface and the pedal arm includes an interior surface with a beveled surface, the beveled surface on the top wall of the spring damper cap abutting against the beveled surface on the interior surface of the pedal arm.

In one embodiment, the spring damper cap defines an opening and the vehicle pedal assembly further comprises a finger which projects outwardly from the pedal arm, the finger extending through the opening in the spring damper cap and into the end of the first spring.

In one embodiment, the spring damper cap is made of an elastomeric material.

There are other advantages and features of this invention which will be more readily apparent from the following detailed description of the embodiment of the invention, the drawings, and the appended claims.

### BRIEF DESCRIPTION OF THE DRAWINGS

In the accompanying drawings that form part of the specification, and in which like numerals are employed to designate like parts throughout the same:

FIG. 1 is a broken, vertical cross-sectional view of a vehicle pedal assembly including a dual coil spring assembly incorporating a spring damper element in accordance with the present invention;

FIG. 2 is an enlarged, broken vertical cross-sectional view of the dual coil spring assembly and base portion of the vehicle pedal assembly shown in FIG. 1;

FIG. 3 is an enlarged top perspective view of the spring damper element of the present invention;

FIG. 4 is an enlarged bottom perspective view of the spring damper element of the present invention; and

FIG. 5 is a broken, enlarged vertical cross-sectional view of a portion of the dual coil spring assembly and a portion of the pedal arm of the vehicle pedal assembly shown in FIG. 1.

### DETAILED DESCRIPTION OF THE EMBODIMENT

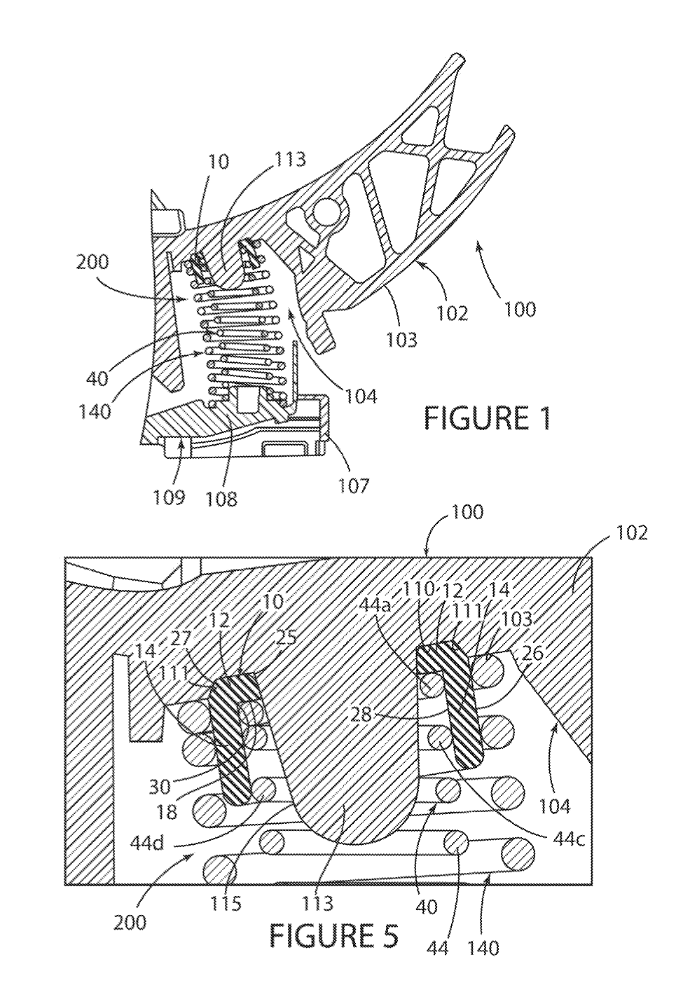

FIGS. 1-5 depict a spring damper element 10 in accordance with the present invention and FIGS. 1, 2, and 5 in particular depict a vehicle pedal assembly 100 including a dual coil spring assembly 200 incorporating the spring damper element 10.

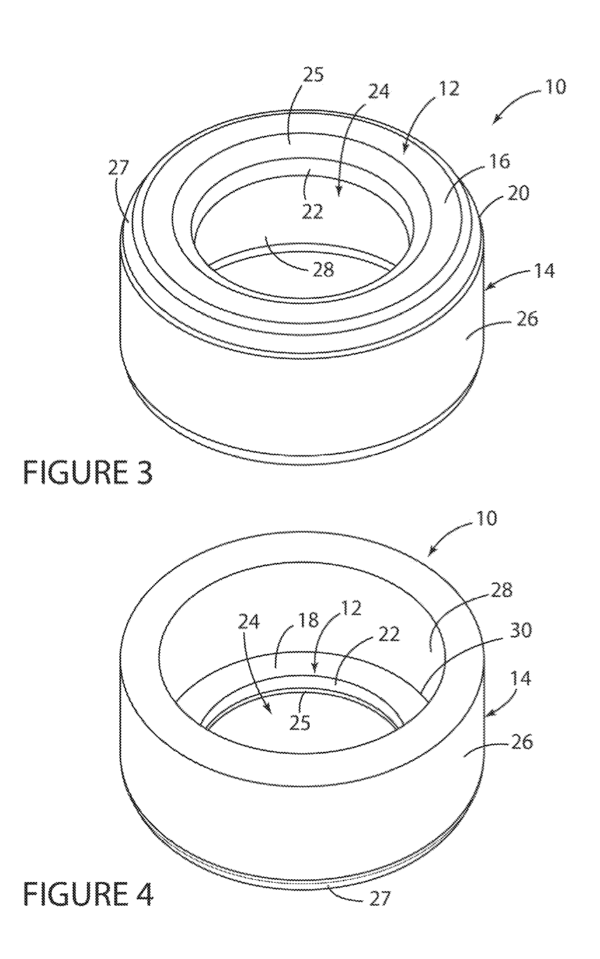

As shown more specifically in FIGS. 3 and 4, the spring damper element 10, which may be made of any suitable noise or friction dampening material including, for example, a rubber or foam or elastomeric material is, in the embodiment shown, generally in the form and shape of an open generally cylindrically-shaped dome or cap or plug including an open, circumferentially extending top wall or roof or portion 12 and a circumferentially extending cylindrically-shaped side wall or portion 14.

The top wall/roof 12 of the spring damper element or cap 10 includes an exterior surface 16, an interior surface 18, a peripheral circumferentially extending outside or outer edge 20, and a circumferentially extending interior or inner edge 22 defining a central, generally circular opening 24 in the top wall/roof 12.

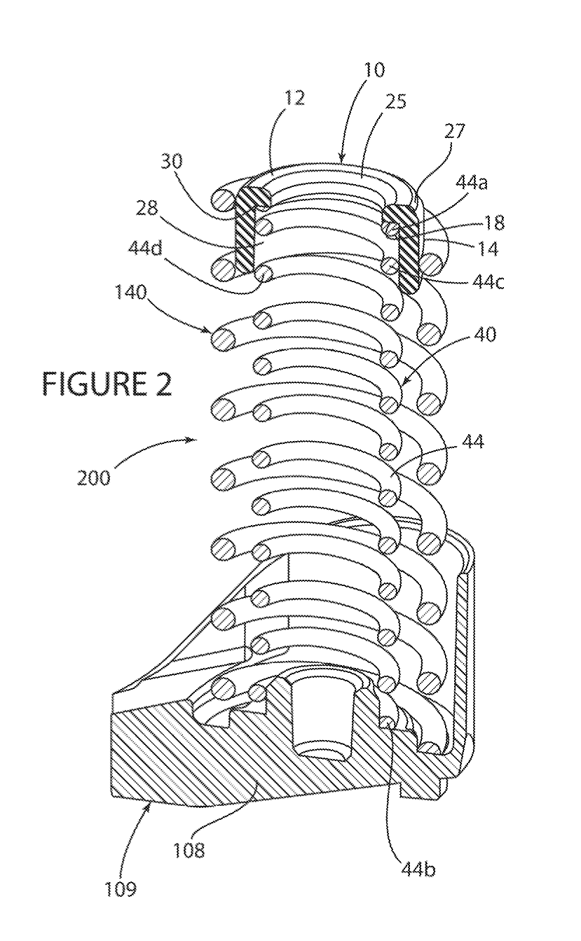

The exterior surface 16 of the top wall/roof 12 additionally defines a first beveled circumferential surface portion 25 (FIGS. 2, 3, 4, and 5) which is formed on the portion of the exterior surface 16 adjacent the circumferentially extending interior vertically oriented edge 22 of the top wall/roof 12 and a second beveled circumferential surface portion 27 (FIGS. 2, 3, 4, and 5) on the exterior surface 16 which is spaced from the first beveled portion 25 and is formed on the portion of the exterior surface 16 adjacent the peripheral outside edge 20 of the top wall/roof 12.

The side wall 14 of the spring damper element or cap 10 depends and projects generally unitarily normally outwardly and downwardly from the peripheral edge 20 of the top wall/roof 12 thereof and, in the embodiment of FIGS. 3 and 4, extends circumferentially completely around the peripheral edge 20 of the top wall/roof 12. The side wall 14 includes an exterior circumferentially extending surface 26 and an interior circumferentially extending surface 28.

The top wall/roof 12 and the side wall 14 of the spring damper element or cap 10 and, more specifically, the joined peripheral edges of the respective interior surfaces 18 and 28 thereof together define a generally L-shaped interior shoulder or flange 30 (FIGS. 2, 4, and 5).

The spring damper element or cap 10 is adapted to be seated on and cover the outermost coil or end of a spring 40 which, in the embodiment of FIGS. 1, 2, and 5, is of the coil/helical type and comprises an elongate bar or wire which has been wound as known in the art into a helix pattern including a plurality of respective individual spaced-apart and generally parallel wire windings or coils 44 (FIG. 2).

More specifically, and as shown in FIGS. 2 and 5, the spring damper element or cap 10 is adapted to be seated and mounted over the outermost end wire winding or coil 44a of the spring 40 in a relationship wherein the flange or shoulder 30 of the spring 40 is seated against the outer edge of the outermost end wire winding or coil 44a of the spring 40 and, still more specifically, in a relationship wherein the interior surface 18 of the top wall/roof 12 of the spring damper element or cap 10 is in abutting relationship with the top surface of the outermost and uppermost end wire winding or coil 44a of the spring 40; the interior surface 28 of the side wall 14 of the spring damper cap 10 is in abutting relationship with the exterior surface of the outermost and uppermost end wire winding or coil 44a of the spring 40 and the exterior surface of at least the next two lower adjacent wire windings or coils 44c and 44d of the spring 40; and the opening 24 defined by the top wall/roof 12 of the spring damper cap 10 is in coaxial alignment with the central opening defined by, and extending through, the length of the helical spring 40.

FIGS. 1 and 5 depict the spring damper element or cap 10 and the spring 40 located in an interior pocket or cavity 104 defined and extending into the underside surface 103 of the pedal arm 102 of a vehicle pedal assembly 100.

The lower outermost end wire winding or coil 44b of the spring 40 is seated against an upper surface of the base arm 108 of a pedal friction device 109 associated with a base or supporting member 107 of the vehicle pedal assembly 100. The opposite upper outermost end wire winding or coil 40a of the spring 40 with the spring damper element or cap 10 seated thereon surrounds a generally cone-shaped finger 113 (FIG. 5) protruding outwardly from the interior surface 103 of the pedal arm 102 and the spring damper element or cap 10 is seated in a recess 110 (FIG. 5) defined in and extending into the interior surface 103 of the pedal arm 102. A portion of the interior surface 103 of the pedal arm 102 defining the recess 110 includes a circumferentially extending beveled segment 111 (FIG. 5). In the embodiment shown, the recess 110 extends circumferentially around the base of the finger 113 and the finger 113 includes an exterior circumferential outwardly converging surface 115.

FIGS. 1, 2, and 5 additionally depict a second helical outer spring 140 which, in combination with the spring 40 and the spring damper element or cap 10 define a dual coil spring assembly 200 which naturally biases the pedal arm 102 away from the base 107 of the vehicle pedal assembly 100. The spring 140 has a diameter greater than the diameter of the spring 40 and has an upper end thereof located and mounted in the pocket 104 of the pedal arm 102 in a relationship wherein the spring 40 is located inside the spring 140 in a double telescoping helical coil relationship, i.e., in a relationship as shown in FIG. 5 wherein the spring 140 defines the outer spring of the double coil spring assembly 200 and surrounds the spring 40 which defines the inner spring of the double coil spring assembly 200.

As also shown in FIGS. 1, 2, and 5, the spring damper element or cap 10 is mounted on the dual coil spring assembly 200 in a relationship wherein the side wall 14 of the spring damper element or cap 10 is sandwiched/wedged in the gap or space between the two telescoping springs 40 and 140, i.e., in a relationship as particularly shown in FIG. 5 wherein the interior surface 28 of the side wall 14 of the spring damper element or cap 10 is in abutting relationship with the exterior surface of the inner spring 40 and the exterior surface 26 of the side wall 14 of the spring damper element or cap 10 is in abutting relationship with the interior surface of the outer spring 140.

According to the invention, the location and positioning of the spring damper element or cap 10 over the end winding or coil 44a of the inner spring 40 in a relationship wherein the spring damper element or cap 10 is wedged and sandwiched between the surface 103 of the pedal arm 102 and the end 40a of the spring 40 prevents the end winding or coil 40a of the spring 40 from contacting or rubbing against the interior surface 103 of the pedal arm 102 and advantageously eliminates the noise and friction which normally occurs as a result of contact between elements of different materials, i.e., a spring 40 typically made of a metal material and a pedal arm 102 typically made of a plastic material.

Also according to the invention, the location and positioning of the side wall 14 of the spring damper element or cap 10 between the inner spring 40 and the outer spring 140 of the dual coil spring assembly 200 advantageously prevents the springs 40 and 140 from contacting or rubbing against each other and eliminates the spring noise which normally occurs as a result of the contact between two coil springs made of metal.

Further, in accordance with the present invention, the process of assembling the vehicle pedal assembly 100 includes the steps of placing the spring damper element or cap 10 over the top end of the spring 40 and wedging the side wall 14 thereof in the gap defined between the inner and outer springs 40 and 140 as shown in FIG. 2; mounting the double coil spring assembly 200 with the spring damper element or cap 10 coupled thereto into the vehicle pedal assembly 100 and, more specifically, inserting the top of the dual coil spring assembly 200 over the finger 113 formed in the recess 104 defined in the lower surface 103 of the pedal arm 102 in a relationship wherein the finger 113 extends through the opening 24 in the roof 12 of the spring damper element or cap 10 and into the end of the inner spring 40; and then positioning and inserting the lower end of the dual coil spring assembly 200 into the base portion 108 of the friction generating assembly 109 located opposite and spaced from the pedal arm 102.

More specifically, and as shown in FIG. 5, the finger 113 and, more specifically, the converging exterior surface 115 thereof, is adapted and shaped to guide the double spring assembly 200 into an assembled position and relationship wherein the beveled surface 27 on the roof 12 of the spring damper element or cap 10 and the beveled surface 111 defined in the recess 110 of the pedal arm 102 are fitted and abutted against each other in a complementary manner thus facilitating and simplifying the location and mounting of the double coil spring cap assembly 200 to the pedal arm 102 during the vehicle pedal assembly process.

Thus, and also in accordance with the present invention, the use of a damper element or cap 10 including a roof 12 extending over the end of the spring 40 allows a portion of the damper element or cap 10 to be wedged and held between the spring 40 and the pedal arm 102 to eliminate the risk of displacement of the damper element or cap 10. Extension of the pedal arm finger 113 through the central opening 24 defined in the roof 12 of the damper element or cap 10 also holds the damper element or cap 10 in place and eliminates the risk of dislodgment.

Numerous variations and modifications of the embodiment described above may be effected without departing from the spirit and scope of the novel features of the invention. It is thus understood that no limitations with respect to the spring damper cap or vehicle pedal assembly illustrated herein are intended or should be inferred. It is, of course, intended to cover by the appended claims all such modifications as fall within the scope of the claims.

I claim:

1. A spring damper element adapted for use in a double coil spring assembly including an inner and outer coil spring, the spring damper element comprising:
a top wall; and
a side wall depending from the side wall and defining an interior shoulder adapted to be seated against the end of the inner coil spring, the side wall being adapted to extend between the inner and outer coil springs of the double coil spring assembly.

2. The spring damper element of claim 1 in the form of a cap including a roof defined by the top wall and adapted to abut against a top surface of the end of the inner coil spring and a generally cylindrically-shaped side wall depending from an edge of the roof and adapted to surround the end of the inner coil spring.

3. The spring damper element of claim 2, wherein the top wall of the cap includes an interior edge defining a central opening in the top wall.

4. A cap made from elastomeric material and adapted to be seated over the end of the inner coil spring of a double coil spring assembly including the inner coil spring and an outer coil spring, the cap comprising:
a top wall including an outer circumferential edge and an inner circumferential edge defining a central opening in the top wall, the top wall being adapted to be seated against a top surface of the inner coil spring; and
a circumferentially extending side wall projecting outwardly from the outer circumferential edge of the top wall, the side wall being adapted to extend in a space defined between the inner and the outer coil springs of the double coil spring assembly.

5. The cap of claim 4, wherein the top wall and the side wall define an interior shoulder adapted to be seated against the end of the inner coil spring.

6. A vehicle pedal assembly comprising at least:
a base;
a pedal arm;
a first spring located between the base and the pedal arm and adapted to bias the pedal arm away from the base; and
a spring damper cap seated over one of the ends of the coil spring and abutting against the pedal arm or the base.

7. The vehicle pedal assembly of claim 6, wherein the pedal arm includes an interior surface defining a recess, the spring damper cap being received in the recess in the pedal arm.

8. The vehicle pedal assembly of claim 6 further comprising a double coil spring assembly extending between the base and the pedal arm and including inner and outer coil springs, the first spring defining the inner coil spring and being located inside the outer spring, the spring damper cap including a side wall extending between the inner and outer coil springs.

9. The vehicle pedal assembly of claim 6, wherein the spring damper cap includes a top wall with a beveled surface and the pedal arm includes an interior surface with a beveled surface, the beveled surface on the top wall of the spring damper cap abutting against the beveled surface on the interior surface of the pedal arm.

10. The vehicle pedal assembly of claim 6, wherein the spring damper cap defines an opening, the vehicle pedal assembly further comprising a finger projecting outwardly from the pedal arm, the finger extending through the opening in the spring damper cap and into the end of the first spring.

11. The vehicle pedal assembly of claim 6, wherein the spring damper cap is made of an elastomeric material.
